(19) United States
(12) Patent Application Publication
(10) Pub. No.: US 2008/0010324 A1
(43) Pub. Date: Jan. 10, 2008

(54) SYSTEM AND METHOD FOR HIGH SPEED DEVICE ACCESS

(76) Inventors: Michael Stebner, Beavercreek, OH (US); Charles Bargar JR., Kettering, OH (US)

Correspondence Address: MCANDREWS HELD & MALLOY, LTD, 500 WEST MADISON STREET, SUITE 3400, CHICAGO, IL, 60661, US

(21) Appl. No.: 11/767,270

(22) Filed: Jun. 22, 2007

Related U.S. Application Data
(60) Provisional application No. 60/816,622, filed on Jun. 25, 2006.

(51) Int. Cl. G06F 17/30

(52) U.S. Cl. 707/204

(57) ABSTRACT

System and methods are provided for more rapidly accessing data from a data container, such as a .ZIP archive, stored on a physical storage medium. Instead of requiring a processes desiring to access a file from the data container to read sequentially through the data container until the file is found, the data container has been modified to include an indication of the location on the physical memory where the desired file may be found. Consequently, the process for reading data from the data container may be advanced directly to the specified physical location without reading the intervening data.

### CROSS REFERENCE TO RELATED APPLICATIONS

This application claims the benefit of U.S. Provisional Application No. 60/816,622 filed Jun. 25, 2006 entitled “HIGH SPEED DEVICE ACCESS SYSTEM AND METHOD,” which is hereby incorporated by reference in its entirety.

### BACKGROUND OF THE INVENTION

The present invention generally relates to a system and method for high speed data access. More particularly, the present invention relates to a system and method for locating data within a data archive without requiring successive read operations on the storage media.

Computer files have been stored in a variety of storage formats and on a variety of storage devices for many years. One such format is a data archive, which is used to store multiple files within a single logical container. One example of a data archive is the ZIP file format created by PKWARE. The ZIP file format is a popular data compression, archival and security format. A ZIP file contains one or more files that have typically been compressed, to reduce their file size, or stored without compression. Currently, a data archive, such as a ZIP archive, is commonly used to combine and store multiple files. Data archives are stored on several different types of storage media such as hard disk drives, dvds, cd-roms, flash memory, tape drives, or any other media capable of storing electronic data.

Data archives may be used for several reasons, such as user convenience. For example, a data archive file containing numerous individual files may be more convenient to use than numerous individual files by themselves. That is, a computer user may wish to transmit a large number of picture files to another computer user via email. The large number of picture files may be contained in a file directory that contains several subdirectories. The title of the subdirectories may convey information relating to the picture files contained within, such as the date the picture file was acquired. In one example, a sender may attempt to send the picture files without utilizing a data archive. In that scenario, the sender must select multiple files to attach to an email. Furthermore, the hierarchical relationship of the picture files contained within subdirectories may be lost. Finally, some email systems may scan incoming attached files and prevent the receipt of certain file types such as picture files.

In an alternative example, a computer user may utilize a data archive to transmit a large number of picture files. As in the previous example, the picture files may be contained in a file directory that contains several subdirectories which convey information about the picture files within. The sender may utilize a software program to create a single data archive from the picture file directory. The data archive contains all of the files with the picture file directory and maintains the hierarchical relationship of the picture files within the directory and subdirectories. Furthermore, the data archive may be created by the sender selecting the file containing the subdirectories and pictures. The sender does not have to select each individual picture and subdirectory. Finally, an email system designed to prevent the receipt of picture files may be configured to allow the receipt of data archives.

A data archive may contain any type of computer file, not just picture files. For example, a data archive may contain text files, audio files, video files, or any other type of electronic data. Additionally, a single data archive may span multiple instances of a physical media. For example, a single data archive may be larger than a single volume of storage media. Many data archive formats allow for the single data archive to be stored on multiple physical volumes. More specifically, a computer user may create a data archive that is 10 gigabytes in size. A standard dvd format may only store 4.7 gigabytes of data. In this scenario, the data archive may be broken up and stored on 3 or more separate dvds and may subsequently be reconstructed.

Any data stored on a storage media may be accessed at several different levels and/or layers. For the purposes of this disclosure, it may be understood that data may be accessed at a minimum of two levels and/or layers. These levels and/or layers include a physical and a logical level and/or layer. Therefore, any data has both a logical location and a physical location. It follows that when a data archive is stored on a storage device, it has both a logical location and a physical location. Furthermore, every logical location has a corresponding physical location on the storage media. Similarly, any data within a data archive also has both a logical location and a physical location.

When a data archive is created, an archive directory is created that includes the location of each of the data files within the archive. In some implementations, the location of a file within a data archive is specified as a logical offset from a structure within the data archive itself. That is, the location of the file may be expressed as a set number of bytes distant from a known feature of the data archive. For example, a data file may be located at an offset of 4,000 bytes from the start of the archive. Because the location of the date file is expressed as a logical offset, such as the number of bytes in this example, the logical offset must be counted until the desired byte offset is reached.

Typically, to locate a file stored at a logical offset within the data archive, the number of bytes comprising the logical offset must be counted by using a succession of read operations on the media on which the archive is stored. In order to perform a read operation from the data storage medium, a read head is typically positioned on the media and activated. Disk read heads are physical mechanisms that read the electronic data from the storage medium. A read head operates using characteristics of the media such as magnetic or optical properties to read information from the media. However, other properties may be used. For example, a read head may be a physical magnetic head or may operate through emulation of a physical head. A read head may also be used to write or erase information from a media. A disk read head is typically activated by and receives its positioning instructions from a disk controller device or process. Common examples of disk read heads are the read head devices found within hard disk drives and cd-rom drives. A read head in a tape drive device performs a similar function but may operate in a different manner. For example, the read head in a tape drive may at times be fixed at a position. The tape drive controller instructs the tape drive mechanism to move the tape media to the appropriate position for reading by the tape drive head.

Positioning a read head typically involves physical movement of either the read head or the media. Therefore, a certain amount of time is typically required to relocate the read head or media from its existing location to the location of the logical offset. Furthermore, to determine if the read head has reached the location of the logical offset, the read head must read every logical data location between the starting location and the location of the logical offset. Consequently, the time spent reading data from the media to determine if the logical offset to a file has been reached may be significant, especially in media for which a read operation is slow or if a large amount of data must be read. Therefore a need exists to more quickly position a device on which an archive is stored for reading and writing the files in the archive.

Most media, including tapes and hard disks, have the ability to position a read head at a certain physical or logical location on the media without performing a read operation. For example, a tape drive may be directed to position, physically or logically, a tape to a certain physical location or a hard disk read head may be directed to a certain sector or block on the hard disk. The relocation of the read head based on a physical or logical location on the media is typically much faster than advancing the read head to that location using successive read operations.

Many common media storage devices may position a read head at any specific physical or logical location on the storage medium. However, in many common file storage systems, the specific physical or logical location on a storage medium corresponding to the location of a data file within a data archive is not known.

Thus, a need has long existed for improved systems and methods for high speed data access to overcome the problems and shortcomings of the current state of the art. A need is especially felt for a system and method for locating data within a data archive without requiring successive read operations on the storage media.

### SUMMARY OF THE INVENTION

One or more embodiments of the present invention provide a system and method of creating a data archive or container, such as a ZIP file, that includes a physical memory location indicator. Additionally, this physical memory location indicator is preferably used to accelerate read operations for data stored within a data archive. For example, a computer system may reposition a file reading component to a new location in a storage medium without accessing intermediate data locations, as is required in previous systems. Additionally, one or more of the embodiments allow for a single data archive to be stored and accessed across a plurality of storage media devices.

### BRIEF DESCRIPTION OF THE DRAWINGS

FIG. 1 illustrates a data archive according to an embodiment of the invention.

FIG. 2 illustrates a storage system according to an embodiment of the invention.

FIG. 3 illustrates a data archive stored on a physical storage medium according to an embodiment of the invention.

FIG. 4 illustrates a data archive with a plurality of files stored in a plurality of storage devices according to an embodiment of the invention.

FIG. 5 illustrates a flowchart for the creation of a data archive.

FIG. 6 illustrates a flowchart of accessing a data file within a data archive.

### DETAILED DESCRIPTION OF THE PREFERRED EMBODIMENTS

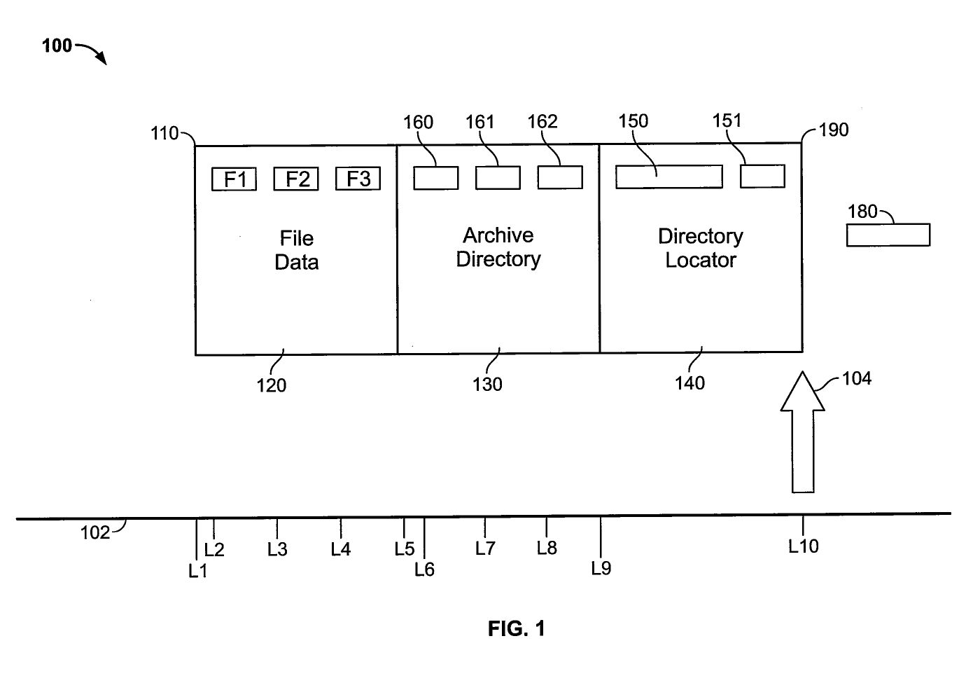

FIG. 1 illustrates a data archive 100 according to an embodiment of the invention. FIG. 1 includes a data archive 100, logical index 102, a read pointer 104, an archive start location 110, file data 120, files F1, F2, and F3, an archive directory 130, a directory locator 140, a high-speed directory pointer 150, high-speed pointer validation information 151, high-speed file pointers 160, 161, and 162, high-speed pointer 180, and an archive end location 190. The data archive 100 may be any of the data archives or data containers referenced below or may be a similar data archive or data container.

In a preferred embodiment, the data archive 100 may be a common data archive format, such as a ZIP file as described above. As shown in FIG. 1, the file data 120, an archive directory 130, and a directory locator 140 are contained within the data archive 100. Further, the data files F1, F2, and F3 are included in the file data 120. Archive directory 130 further includes high-speed file pointers 160, 161, and 162 which correspond to files F1, F2, and F3 respectively. Directory locator 140 further includes high-speed directory pointer 150. In a preferred embodiment, the high-speed pointer validation information 151 is located adjacent to the high-speed directory pointer 150. In other implementations, the high-speed pointer validation information 151 may be located at other locations within, or outside of the data archive. As further described below, the data archive 100 may reside or be stored on any known electronic storage format, such as a hard disk drive, tape drive, optical media, or flash drive as described later in the patent.

Additionally, the data archive 100 may be compressed and/or encrypted. For example, when the data archive 100 is a .ZIP archive, the archive may be compressed and encrypted as described in co-pending application Ser. No. 10/620,960 filed Jul. 16, 2003 entitled “METHOD FOR STRONGLY ENCRYPTING .ZIP FILES.” Alternatively, the .ZIP archive may be compressed and/or encrypted as described in the APPNOTE specification for the .ZIP archive available at the website of PKWARE, Inc, the assignee of the present application, at www.pkware.com.

Further, in addition to the data archive 100 as a whole being compressed and/or encrypted, individual portions of the data archive 100 may be compressed and/or encrypted. For example, when the data archive 100 is a .ZIP archive and the .ZIP archive includes high-speed pointers, the high-speed pointers may be compressed and/or encrypted regardless of whether the remainder of the .Zip archive is compressed and/or encrypted, or may be compressed and/or encrypted in addition to the compression and/or encryption of the remainder of the .ZIP archive. Further, other data security techniques may be employed to protect the high-speed pointers. Additionally, the high-speed pointers may include a pointer to a data security element inside the data archive. For example, when the data archive 100 is a .ZIP archive and the archive directory 130 is encrypted, the Zip archive may include a pointer to a data security element that describes the encryption type applied to the archive directory. Thus, the process may proceed to read the type of encryption applied before reading the encrypted data so that the decryption operation may proceed more rapidly. Additionally, the process described above with regard to the archive directory 100 may apply to individual files or other data contained in the archive directory 130.

The data archive 100 also includes a logical index 102. The logical index 102 further includes logical indices L1 through L10, although the actual number of logical indices may vary and the indices L1 through L10 are chosen for illustrative purposes. The logical index 102, with logical indices L1-L10 are logical offsets representing desired structures inside the data structure of the data container. For example, the archive start location 110 may be represented by logical index L1. Similarly, the archive end location 190 may be accessed at L10. Further, other elements of the data container may be referenced by other logical indices, such as the directory locator at L9 and file F2 at logical index L3.

The read pointer 104 represents the logical position from which data is being read out of the data container 100. For example, if the data container is stored on a hard disk, the read pointer 104 may represent the logical position of the data container from which the hard disk's read head is reading data. As illustrated in FIG. 1, the read pointer 104 is at logical index L10. As the read pointer 104 reads data from the data container, the read pointer may travel to other logical indices within the data container 100. That is, the read pointer 104 may preferably be advanced to any position L1 through L10 along the logical index 102 of the data archive 100.

In one exemplary operation, a computer user requests file F2 stored within the data archive 100. The computer system then instructs the storage medium to access file F2. In response, the storage medium places the read pointer 104 at the archive end location 190, which corresponds to logical index L10. The computer system instructs the storage medium to advance the read pointer 104 to the directory locator 140. At the directory locator 140, the read pointer 104 accesses the high-speed archive directory pointer 150 located at logical index L9. After determining the high-speed archive directory pointer 150, the computer system instructs the read pointer 104 to cease reading data within the directory locator. Next the computer system advances the read pointer 104 to storage medium specific location of the start of the archive directory 130 identified by the high-speed archive directory pointer 150. After the computer system repositions the read pointer 104 to the location of the start of archive directory 130, which corresponds to logical index L5, the computer system begins reading data stored in the archive directory 130. The read pointer 104 traverses the archive directory until the computer system reads the high-speed pointer corresponding to the desired file. In this example, the read head 104 advances along the archive directory until it reaches the logical index L7, which holds the high-speed file pointer 161 corresponding to the location of file F2. The high-speed file pointer 161 contains the media-specific file location of file F2, which corresponds to logical index L3. Finally, the computer system instructs the read pointer 104 to advance to the location of file F2.

One embodiment of the present invention allows the read pointer 104 to immediately advance to location L3 without requiring the read pointer 104 to sequentially read all of the data located between logical indices L10 through L4, as is required in the prior art access systems. This accelerated advancing of the read pointer 104 is referred to as a “jump” or “high-speed” advance.

In order to perform a jump advance, one embodiment of the invention uses location pointers which are more fully described below. These “high-speed” pointers store device and/or media specific information which allows a read pointer 104 to move from a starting location to a location referenced by the pointer without reading media locations in between the starting location and the pointer location.

These pointers may include information regarding where the data within the archive 100 is located on the physical device in addition to or instead of where the data is logically located in the archive. This location and positioning information contained within these pointers may be expressed in absolute or relative terms.

As an example, referring to FIG. 1, the starting location of the data file F2 may be referred to in absolute terms as L3. However, the same file location L3 may be expressed in relative terms such as a distance of 7 measurement units from L10 to L3, where the type of measurement unit may vary depending on the implementation. That is, the read pointer 104 must advance 7 units from the end of the data archive to reach the location L3.

In other embodiments, a read pointer 104 sequentially accessing data along the logical index must access several thousand logical units before reaching the desired file. For example, a desired file may be located in a data archive with logical index with 2048 positions. A read pointer 104 advancing sequentially along logical index from archive end at L2048 accesses 2045 logical indices to reach a file stored at logical index L3 resulting in increased time delays and decreased efficiency. A certain non-trivial amount of time and resources is spent in this sequence of events. Most importantly, while the read pointer 104 is occupied in performing these tasks, other processes may not be able to make use of the read pointer 104 to access and utilize data located elsewhere within the storage medium. Returning to the discussion of this embodiment of the invention, the location of file data within the data archive may be expressed in absolute terms such as a particular physical or logical address or in relative terms as an offset location expressed in the number of bytes.

Embodiments of the present invention are capable of employing either method of addressing as well as any method of addressing which may be used to provide a “jump advance” instruction to the read head.

Additionally, these high-speed pointers may include information, attributes and characteristics of the storage device and provide instructions as to how to position the device, media, and the read pointer 104 to read the data. In other words, the pointers may identify the storage media to be a hard drive having a particular geometry, for example. The pointers may also include information about the physical sectors of the location of the data in absolute or relative terms and may provide other information identifying the drive to be a particular model made by a particular manufacturer. Once this information is available, this information may be used to quickly advance the read pointer 104 to the desired location L3. Consequently, in the case of a hard drive, the read pointer 104 may be advanced to a particular sector, without accessing the sectors disposed along the path between the start location and the location referenced by the pointer. On the other hand, in a flash drive, where there is no physical read head, a virtual read head or a software program may be directed to a particular memory address. These high-speed pointers contain information to quickly advance the read pointer 104 to the desired location L3.

In some embodiments of the invention, the data storage device may access only a portion of a file. In these embodiments, the pointers direct the read pointer 104 to a location within a file. That is, the pointer references a specific location, sector, or element that is not the start or end of a file. The pointers may also identify different elements or sections such as individual file data and or metadata of a data archive. The term metadata is used to describe various attributes, portions or characteristics of data. At a basic level, it may be understood as data about the data. In an embodiment of the present invention, the metadata may include information related to the archive directory, file headers, encryption and so on.

In its most generic sense, metadata is data relating to data. In this specific context, metadata may include data about the archive directory, file headers and encryption data of a data archive. One example of metadata is the name of the file. Another characteristic about a file is the size of the file before being compressed by a data compression algorithm and placed into the data archive 100. Another characteristic about a file is the size of the file as it resides within the data archive 100 after being compressed by a data compression algorithm. Other characteristics of files may also be used.

A read pointer 104 may correspond to an electromechanical object such as a drive head. With a hard drive, the read head may be physically attached to a physical arm and in the case of a tape drive, the tape may be in contact with a physical read head. However, the read head implementation may differ depending on the memory type and access system. For example, flash memory storage devices typically do not have physical read heads. Similarly, many other types of storage devices may also no longer contain a physical read head. In such devices, the physical read head has often been replaced with a virtual or logical read head which corresponds to the current location of memory actively being accessed. Virtual read heads are able to access non-contiguous locations within the storage media with extremely low time delays. However, even though they are not limited in their movement, virtual read heads are still constrained by existing systems and methods of accessing data located within data archives. Meaning, that even a virtual read head sequentially reads locations L1 to L3 in order to reach the desired file F2. Additionally, while the virtual read head is occupied in doing so, it may not be utilized by other processes which may desire to access data located elsewhere.

In one example of an embodiment of the invention, a computer system may provide access to file F3 using high-speed pointers as follows. First, the computer system instructs read pointer 104 to move to the archive end location 190 referenced by logical index L10. The read pointer next reads the contents of the directory locator 140. The directory locater contains high-speed directory pointer 150. The computer system reads the contents of high-speed directory pointer 150 to determine the location of the archive directory 130. The computer system then instructs the read pointer 104 to advance to the starting location of the archive directory 130 which is located at logical index L5. The read pointer 104 advances to logical index L5 without accessing the data at the intervening logical index locations between the read pointer 104 starting position and logical index L5. When the read pointer 104 reaches the archive directory 130, the computer system reads the high-speed file pointers. After reading the high-speed file pointer 162 corresponding to the location of file F3, the computer system once again instructs the read pointer 104 to advance to a location without accessing intervening data. In this example, the read pointer 104 advances to L4 where the computer system may read file F3.

In alternative embodiments, files may be stored in a plurality of data containers similar to data archive 100. Also, data archive 100 may be created without including a data file and just including an archive directory and/or directory locator. In yet another embodiment of an invention, a directory locator may be found at the start of a data archive rather than the end. In this embodiment, the data pointer 104 may start to access the data archive 100 at the archive start 110.

The files stored within the data archive 100 are typically accessed by a computer process or computer user. The term process typically refers to any hardware device, program, routine, file, software, operating system or other computing element. The file may be accessed for a variety of purposes such as to create, edit, read, modify, write or otherwise interact with either a portion or the entirety of the data archive. When a file in the file data 120 portion of the data archive 100 is accessed, the data archive 100 is read from the archive end 190. During the read process, the high-speed archive directory pointer 150 is accessed. As further described elsewhere, the high-speed archive directory pointer 150 was previously determined based on the media on which the data archive 100 has been stored. When the high-speed archive directory pointer 150 is accessed, the read pointer 104 may cease to read the data in the directory locator 140 and instead may direct the device 102 that operates the read pointer 104 to position the read head 104 to the media-specific location expressed by the high-speed archive directory pointer 150. For example, the high-speed archive directory pointer 150 may be a pointer to a specific location on a backup tape. Once the high-speed archive directory pointer 150 is encountered, the tape may be logically or physically positioned to the indicated tape position using high speed tape positioning operations. More specifically, the tape drive controller may advance the tape media from a starting position to a position referenced by high-speed pointer 150 without the tape head 104 sequentially reading file data between the starting position of tape and the position referenced by high-speed pointer 150.

In FIG. 1, this high-speed directory pointer 150 is shown to be located within the data archive 100 and adjacent to the archive directory 130. However, as a practical matter, the archive directory pointer 150 may be located anywhere within the data archive 200 or may be external to the data archive 100. That is to say that the high speed directory pointer may be stored at any relative location within the data archive 100 or separate from the data archive 100.

Once the high-speed archive directory pointer 150 has been used to reposition the read pointer 104 at the start of the archive directory 130, the read pointer 104 begins to read data from the archive directory 130. The read pointer 104 continues to read data from the archive directory 130 until the read pointer 104 encounters high-speed file pointers 160-162 corresponding to files F1-F3.

Similar to the high-speed pointer 150, these file pointers 160-162 may also be stored at any location within the data archive 100 or may be separate from the data archive 100. Additionally, more than one high-speed file pointer may be encountered. Preferably, the high-speed file pointers 160-162 may be read and copied into program memory or other high-speed storage medium for use when directing a device to read a file. Similar to the operation described above with regard to the high-speed archive directory pointer 150, once the read pointer 104 encounters the high-speed file pointer 161, it directs the device that operates the read pointer 104 to position, physically, or logically the read pointer 104 to the media-specific location expressed by the high-speed file pointer 161.

For example, when a computer or file system process operates to access file F1 in the file data 120, the process reads the archive directory 130 until the process encounters the high-speed file pointer 160 for file F1. The process then instructs the read pointer 104 to cease to read the data in the archive directory 130 and instructs the read pointer 104 to be repositioned at the media-specific location corresponding to file F1 as specified by the high-speed file pointer 160. Once the read pointer 104 has been repositioned, the process begins to read data from file F1.

Alternatively, instead of ceasing to read data in the archive directory 130, the process may copy the high-speed file pointer data 160 into program memory or another storage medium. After copying the information from the high-speed file pointer 160, the process may instruct the read pointer 104 to continue to read the archive directory 130 to locate additional high-speed file pointers 161 and 162. After the read pointer 104 has read the file pointers 160, 161, and 162, the process may instruct the read pointer 104 to be repositioned at any of the media-specific location corresponding to files F1-F3 as specified by high-speed file pointers 160-162. For example, a process operating on computer with an optical storage device may instruct the read head 104 on the optical storage device to move from a position corresponding to the archive directory 130 to a position corresponding to high speed pointer 162. After the read head 104 reads data from the position corresponding to pointer 162, the read head 104 may “jump” or perform a high-speed advance to the position on the media corresponding to high-speed pointer 160. More specifically, the read head 104 may move from the position on the media of file F3, to the position of file F1 without accessing any of the data stored at intervening positions, such as file F2. Alternatively, the read head 104 may access some of the data stored at intervening positions. Note that the read head 104 may be said to “advance” when it moves from file F1 to F3, or when it moves from file F3 to F1. Although files F1-F3 are illustrated as being contiguous, in alternative embodiments of the invention files F1-F3 may be located at any positions on a single storage medium, or on a plurality of storage devices. A file archive may contain high-speed file pointers that point to locations on separate file storage volumes. This scenario is discussed in more detail elsewhere.

Returning to the contents of the directory locator 140, the directory locator 140 preferably includes device positioning information used to locate the archive directory 130. The information about the archive directory 130 may include high-speed pointer information 150 to locate the archive directory 130 and high-speed pointer validation information 151, preferably including media device type information, media unit type information, media volume information, a file identifier, and any other validation information used to verify the applicability of high-speed pointers. Other information about the archive directory 130 may also be included.

Validation information preferably includes characteristics of a device/unit where a high-speed pointer may be used in order to provide greater certainty that high-speed pointers will accurately position a read head when reading a data archive. When creating a data archive that utilizes high-speed pointers, validation information about the high-speed pointers is preferably stored with the data archive. For example, the validation information may be written to the data archive as an extension to the directory locator 150, or adjacent to the directory locator 150.

When reading a data archive that contains high-speed pointers, the validation information is preferably read along with the high-speed pointer and is used to determine if the high-speed pointer is available to position the read head of the device from which the data archive is read. If the high-speed pointer validation information in a data archive matches the characteristics of the device, then the high-speed pointer is available to correctly position the read head of the device to read the data archive. If the high-speed pointer information does not match the characteristics of the device, the data archive may still be read using the device however high-speed pointers are typically not utilized to read the data archive.

Returning to the contents of the archive directory 130, the archive directory 130 preferably includes device positioning information used to locate file data. The archive directory 130 also includes information about file data 120. The information about file data 120 includes directory entry file locator information. Directory entry file locator information includes high-speed pointer information to locate files 160-162. Other information about file data may also be included.

Additionally, the device-specific information stored in the data archive 100 is preferably portable. That is, the device-specific information may be stored in the data archive 100 even after the data archive 100 is removed from the specific device or media for which the device-specific information has been defined. Thus, a single data archive 100 may include device-specific and/or media specific information for a number of storage devices. When the data archive 100 includes device-specific information with regard to more than one device, the information in the directory locator such as the validation volume may be used to select the correct set of device-specific information from the available multiple sets of device-specific information. Alternatively, the device-specific information may be purged when the data archive is read from the storage media.

The media containing the data archive 100 file is preferably portable for use on compatible devices at alternative locations and/or device media readers capable of processing the high-speed pointer information. That is, the information is not necessarily dependent upon a specific reader device. For example, media containing a data archive that is written using a device in one system location may be read on a different device in the same location or at another system location.

The concepts above may be applicable to all storage media devices that support drive head positioning instructions. Specific examples include but are not limited to magnetic tape devices, hard disk drives and controllers, virtual tape devices, CD-ROM, and DVD.

With regard to specific information of the system described above to .ZIP files, the standard .ZIP file definition may be modified to include .ZIP extended end-central attributes and .ZIP central directory entries. The .ZIP extended end-central attributes include device positioning integrity check information and start of central directory positioning. The device positioning integrity check information preferably defines the device itself and may be used to validate that the accessing process has the correct device by volume and sequence numbers. The device positioning integrity check information includes unit type which identifies the type of storage device, first volume ID for archive start, and first volume file sequence. The First Volume ID identifies the volume (i.e. which tape of a set) for the device identified by Unit Type where the data archive starts. The First Volume file sequence identifies where within a volume, the file logically begins.

The start of central directory processing preferably provides the device-specific high-speed pointer data to the archive directory 130. The data may include the block-id of a specific storage media as well as a byte offset in the block. The .ZIP central directory entries are preferably positioned inside the archive directory 130 and preferably provide the device-specific high-speed pointer data to individual data files. As above, the pointer data may include the block-id of a specific storage media as well as a byte offset in the block.

In alternative embodiments, high-speed pointers may be stored outside of data archive 100. For example, as shown in FIG. 1, high-speed pointer 180 is located outside of data archive 100. High-speed pointer 180 may act as high-speed pointer to the data archive 100, the directory locator 150, the archive directory 130, file data 120, or any of the files or high-speed pointers within the data archive 100. Furthermore, the high-speed pointer 180 may reside on a physically or logically separate storage medium from the data archive 100.

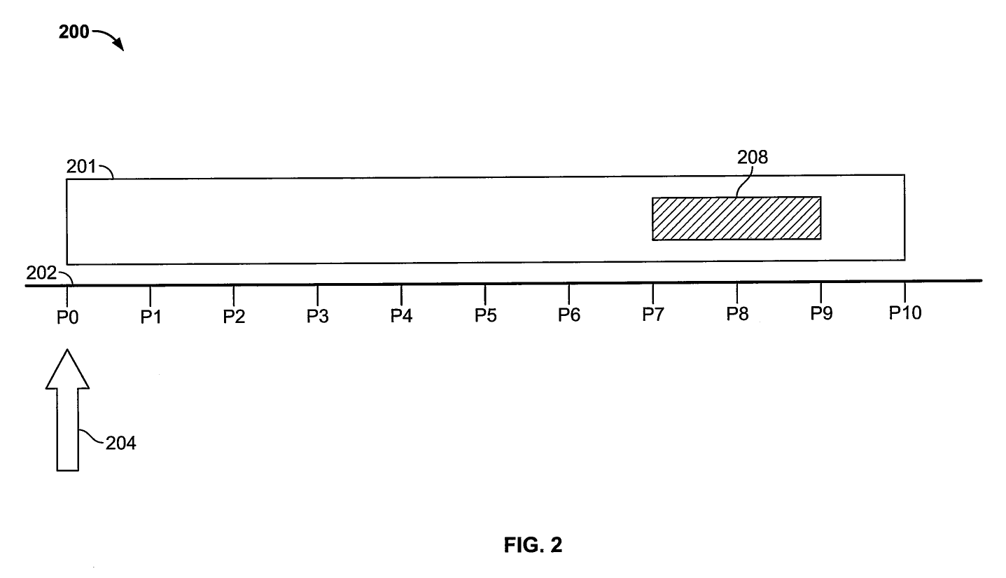

FIG. 2 illustrates a storage system 200 according to an embodiment of the invention. The storage system 200 includes physical storage memory 201, physical storage index 202, physical memory location indices P0 through P10, drive head 204 and data archive 208.

Turning to the physical storage memory 210, the terms physical storage memory, storage media/medium, storage device, and physical memory may be considered analogous because they refer to the nature of the storage where the data archive 208 is stored. For example, the storage may be on a tape drive, disk drive, a flash memory based device, optical media such as CD/DVD media or any other device or media capable of storing data archives. Furthermore, the storage may be either persistent or non-persistent memory.

The physical storage memory 201 includes a physical storage index 202 used to reference particular individual discrete physical locations within the physical storage memory 201. The storage index 202 tracks the physical location of electronic data within the storage memory 201. As illustrated in FIG. 2, the data archive 208 is physically disposed in locations P7 through P9 on the storage medium 201. In operation, a computer system accesses the data archive 208 by moving the drive head 204 to the physical location of the end of the data archive 208. For example, a computer system may instruct the hard disk drive storage medium 201 to move the hard disk read/write head 204 to physical location P9 to begin reading the contents of data archive 208.

As described above, the data archive 208 may include high-speed pointer information used to locate data within a data archive. The high-speed pointer information may depend on specific information and characteristics relating to the physical storage memory 201. The high-speed pointer may also be referred to as a physical memory location indicator. The media device type and media unit type are used singly, or in combination to identify the type of media for which the high-speed pointer information applies, such as tape drive or hard disk, for example, and also preferably identifies the specific device type that is being used for storage. One example of identification information is a unique factory identification code assigned by the manufacturer of a device used to identify a specific device type. More specifically, a hard disk drive manufacturer may provide a unique factory identification code with each hard drive it produces. Each hard disk drive identification code may include information identifying the drive manufacturer, the storage capacity of the drive, the drive geometry information, and other information relating to file storage operations.

The media validation volume and media validation file identifier are specific characteristics related to defining information for the media that is being used for storing an archive 208 and also serves to ensure that the related device-dependent high-speed pointer information is viable for use on the reader device during information retrieval. The validation volume and validation file identifier are preferably unique to a specific device. The file identifier may be a logical or physical representation, for example a file sequence number, file name, or track identifier.

A single device may make use of several types of storage media. For example, a single computer may be equipped with several hard disks, multiple DVD drives, and a tape backup drive. Consequently, a data archive 100 may be duplicated or relocated from one storage media to another. To address this eventuality, these pointers may point to locations of a data archive on a single media volume or separate media volumes. As another example, a single data archive may contain pointers for various storage media devices. These various devices may be any and all such devices known to the system controlling the device 102 or may simply be various devices on which the data archive 100 has previously been stored on. Therefore, these pointers may point to locations of a data archive 100 on a single media volume or on separate media volumes. Another feature of these pointers is that they may be stored anywhere within the data archive 100 or exist separate and independent of the data archive. That is to say that they need not necessarily be stored within the archive 100 itself for the invention to be operative. Furthermore, when the data archive 100 is duplicated or relocated from a device 102 to another location within the same device 102 or a different device, the pointers may or may not remain associated to the archive 100.

Finally turning to the data archive 100, the term “data archive” refers generically to a logical collection or bundle of data usually used for compression or archival of data. Some common examples of file extensions associated with data archives include .ZIP, .CAB, .ARJ, .RAR, .TAR, .TRS, DFDSS Dumps or FDR Dumps. Additionally, the term archive need not imply long term storage without the data being actively accessed. Additionally, at least some embodiments are not limited to archives which result in a total reduction of data size when the files are bundled. That is, the files located within the data archive may be stored with or without compression or other transformation.

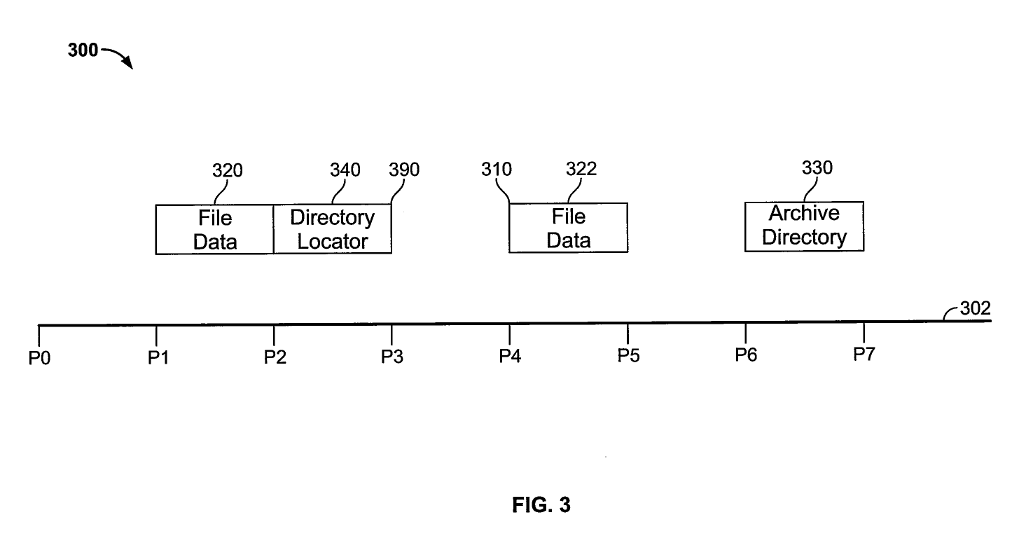

FIG. 3 illustrates a data archive 300 stored on a physical storage medium according to an embodiment of the invention. The data archive 300 includes a physical storage index 302, an archive start 310, file data 320, file data 322, archive directory 330, directory locator 340, and archive end 390. The physical storage index 302 represents consecutive and/or contiguous physical memory locations within a memory device.

As a practical matter, computer files may or may not be stored in a contiguous manner and in actual practice are often stored in a non-consecutive manner. More specifically, a computer file with 4 blocks of data may be stored on a physical medium in such a way that the 4 blocks of data are stored out of order. That is, the first of the four blocks may be stored in between the second and third blocks. Furthermore, each of the 4 blocks may be stored in memory locations surrounded by data blocks associated with other files. This type of file storage scenario is commonly found in computer and file systems having data that is fragmented or scattered across several physical or logical locations within the storage media.

One embodiment of the invention is adapted to such a scenario. For example as illustrated in FIG. 3, the data archive is split into four blocks: file data 322, directory locator 340, file data 320, and archive directory 330. The four blocks occupy memory locations P1, P2, P4, and P6 respectively. As indicated by 310, the file data 320 block is considered the start of the data archive. However, the 320 block is located at physical memory location P4, which is 3 positions after file data block 322 located at memory location P1. Furthermore, the directory locator 340 which contains archive end 390 is stored at memory location P2 which is two positions before memory location P4. Additionally, file data 320 is located between P3 and P5, which may hold data not related to data archive 300. However, the embodiment of the invention is capable of reading and storing data archives in such a manner. That is, the data archive may be stored with information allowing the data archive to be accessed in logical order even when stored in a nonconsecutive and noncontiguous file system.

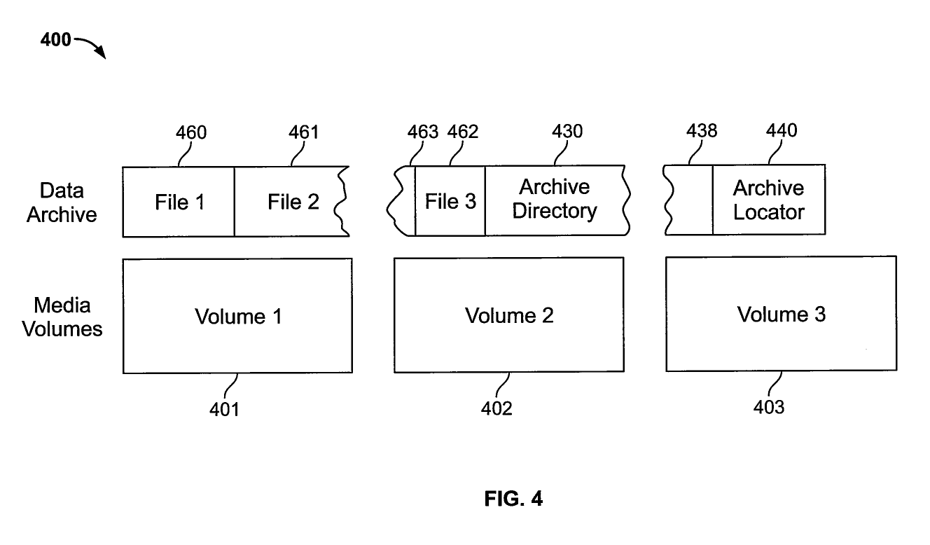

FIG. 4 illustrates a data archive 400 with a plurality of files stored in a plurality of storage devices according to an embodiment of the invention. FIG. 4 includes a data archive 400, media volumes 401, 402, and 403, files 460 and 462, a first file portion 461, a second file portion 463, a archive directory portion 430, a second archive directory portion 433, and a directory locator 440.

In some real-world implementations, the data archive 400 may be larger than the space available on a single storage medium. When a distributed file system or some other storage system with multiple volumes is being employed, it is not uncommon for computer files to be scattered across several volumes. This fragmentation or scattering may occur due to the standard operation of common file systems such as those used in operating systems. Alternatively, data archives may need to be stored on multiple volumes due to storage space limitations. For example, if a data archive 400 comprises more bytes than may be placed or contained within a single contiguous volume, the data archive 400 may be stored on multiple media volumes. Such multiple media volumes need not necessarily be of identical nature. That is to say, if the first volume is a CD, the second volume may be a tape or a flash memory device. Thus, one embodiment of the invention, the data archive 400 may be segmented and placed on a plurality of storage devices and FIG. 4 illustrates one such exemplary embodiment.

In FIG. 4, the data archive 400 may be stored on the number of media volumes required to meet, or exceed the storage requirements for the data archive 400. As illustrated in FIG. 4, the data archive 400 is stored on media volumes 401, 402, and 403. For example, the media volumes 401, 402, and 403 may have a capacity of 50 megabytes, but the data archive may require 140 megabytes of storage space. Consequently, the data archive 400 may be split up into smaller segments and stored in a plurality of different storage medium. Additionally, one embodiment of the invention allows a single file to be split into multiple components and stored on multiple data storage media. As shown in FIG. 4, a file may be split into a first file portion 461 stored on volume 401 and the second file portion 463 stored on volume 402. Similarly, an archive directory may be stored across multiple storage devices as shown by the first archive directory portion 430 and the second archive directory portion 433.

When the data archive 400 stored across multiple media volumes is read, the positioning information may be used to directly access the media volume on which the information resides. Volumes which do not contain required information need not be accessed, or may not even be mounted. Each volume may be read from the same reading device. Alternatively, each volume may be read using a separate reading device. Each separate reading device may access information at the same time and one reading device does not need to wait until another reading device has finished reading. The ability for each reading device to directly access a media volume may reduce the time required to read a data archive.

Thus, an embodiment of the present invention may be conceptualized as extending the storage format of the .ZIP archive to facilitate high-speed retrieval when the .ZIP file is read. The high-speed file pointers to the locations of 460, 461, 463, and 462 may act conceptually as an index to file data to allow a process controlling a read head to move the read head directly to a desired file contained within a data archive rather than instructing a read head to begin reading all data within the data archive until the read head reaches the desired file.

Further, the use of the high-speed device access methods for reading and writing a data archive 400 file may be user selectable. A user creating a data archive 400 using an archive creation program on a device supporting high-speed positioning may command the process to use high-speed positioning methods on one data archive file. Similarly, a user may command another archive creation process to not use high-speed positioning methods when creating a data archive file.

Commanding an archive creation program to use high-speed positioning methods may be performed using command parameters passed to the archive creation program as program arguments, switches, flags or other data types known to those of skill in the art to command a program. Command parameters may be passed to an archive creation program using a graphical user interface. Other program interfaces may be used.

With regard to the high-speed pointers, in one example, the high-speed pointers may instruct the accessing process to advance a specified number of bits, bytes, or other data symbols. Alternatively, the high-speed pointer may direct the process to a specific physical, logical, or geometric position on the media.

A high-speed pointer may point to a location in a data archive that represents different types of information within the data archive. One example may be a pointer to a file that has been written to the data archive. Further, pointers may point to record structures containing information about a file in the data archive or about the data archive itself. These record structures identify metadata used by programs that read and write data archives. One example of a record structure is a Local Header record as defined for data archives in the ZIP format. A Local Header record stores information about a file in a ZIP file. This information includes the name of the file, the compressed and uncompressed size of the file and other characteristics of the file. A second example is a record structure that may be used to store information about security that is applied to the data archive or to the files it contains. This may include information about data encryption or digital signing characteristics used within the data archive. A third example is a record structure that is used to store information about how a data archive may be split into segments. Each segment may be written to a separate media volume.

Additionally, although the exemplary .ZIP type of data archive was discussed above, other types of data archives, such as .CAB, .ARJ, .RAR, .TAR, .TRS, DFDSS Dumps or FDR Dumps for example, may be employed. Data for an archive may reside on a single medium or may alternatively reside on more than one media.

In the embodiment discussed above, the high-speed pointers derived from media-specific information are located in the data archive itself. High-speed pointers may reside in any location within the archive. They may be near the beginning or the end of the data archive or interspersed with other information in the archive. Alternatively, the high speed pointers may be located in a separate file that accompanies the data archive, or may be stored on a remote server or alternative media platform.

Additionally, the directory locator is preferably located near the end of the data archive, but may alternatively be located anywhere in the data archive or outside the data archive, for example in a separate file or a remote server or alternative media platform. Furthermore, device-specific information stored in the data archive may be preserved and passed when the data archive is removed or copied from the specific device or media. Alternatively, the media-specific information may be removed from the data archive when the data archive is removed or copied from the specific device or media. The media-specific information may remain on the media as a separate file or may alternatively be discarded.

One consideration to note is that advancing a set number of bytes within a data archive and advancing a set number of bytes along a storage media may not necessarily arrive at the same position. For example, in some storage media files are not stored linearly and may be broken up into several locations on the media. Consequently, a read operation may be necessary to read through the data archive and determine the locations of the remaining archive. Conversely, advancing a set number of bytes along the storage media provides a firm target point that may be accessed using a high-speed operation.

Another consideration to note is that although modern software design principles advocate the desirability of making software as transparent as possible with regard to the underlying media, it is noted that an increase in speed of accessing desired data may be obtained by adapting the data archive to specific media.

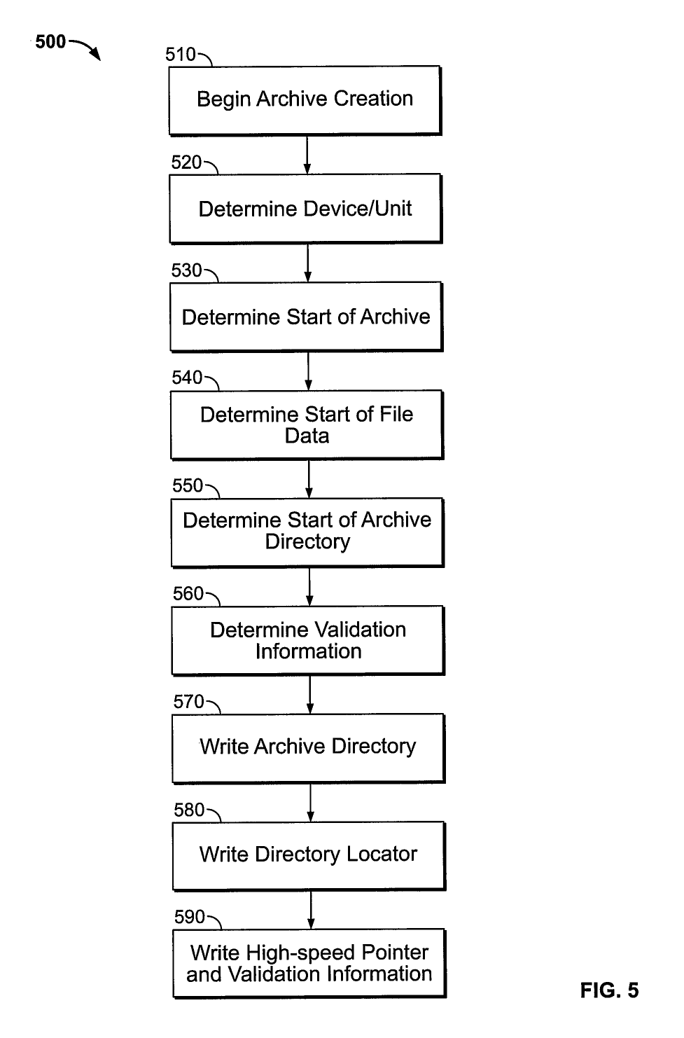

FIG. 5 illustrates a flowchart 500 for the creation of a data archive. First, in step 510, a data archive is received for storage on a device. The data archive may be created by a software program or process to be stored on a portable storage medium. For example, a computer user may direct a program to create a zip file to be stored on one or more backup tapes.

Next, in step 520, the type of device is determined. As described above, in determining the type of device, various types of information may be utilized such as whether the device is a hard disk drive or a tape device. Information pertaining to the physical layer information about the device may also be utilized to identify the type of device.

Next, in step 530, the start location of the data archive is determined with respect to the media on which the data archive is stored. As previously described, the data archive has a start and end location on the storage media. Here, in step 530, the start location of this data archive is determined as it relates to the media. Similarly, as described above, the location may be expressed in absolute or relative terms at a physical or logical level.

Next, in step 540, file data is received for storage within the data archive as file data 120. The start location of a first received file is determined. As previously explained, the start location of data files within the data archive is utilized to provide the read head with positioning instructions. The start location is determined so that it may be subsequently used to provide such positioning instructions. In one embodiment of the invention, the start location is determined at a physical level.

File data for the first received file is written to the data archive for storage. File data for the first received file may be compressed and/or encrypted. As previously described, metadata containing information about the file may be written to the data archive preceding the file data. Information about the file may include high-speed pointers that provide a jump to the actual file data. Also as part of step 540, the start location of a second received file is determined. File data for the second file is written to the data archive for storage. Metadata for the second file may also be written to the data archive. Metadata for the first and second file may also be compressed and/or encrypted.

Next, in step 550, the start location of the archive directory is determined with regard to the device that the data archive is stored on. As previously described, and similar to the location of the data archive, the location of the archive directory is determined as it relates to the storage media. Again, this location may be expressed in absolute or relative terms at a physical or logical level. In one embodiment of the invention, the location of the archive directory is determined at a physical level.

Next, in step 560, the validation information is determined. As previously described, the validation information is determined in regard to the device used for storage of the data archive and of the high-speed pointers that may be used to accurately position the read head of the device. Various types of information about the device may be utilized such as media device type, media unit type, media volume information, or other information.

Next, in step 570, the archive directory is written. Metadata about each file written to the archive is stored including high-speed file pointer information 160-162. This high-speed pointer information may subsequently be used when reading the data archive to position the read head. The archive directory including the high-speed file pointer information may be compressed and/or encrypted.

In step 580, the information regarding the start of the archive directory is stored as a pointer within the directory locator 140. As described previously, a pointer may include any and all information which may be utilized to provide positioning information to a storage device's read head. Here, the pointer contains information that may be utilized to immediately advance the read head to the start of the archive directory. In one embodiment of the invention, the physical address of the start of the archive directory is stored as a pointer. High-speed device positioning information may be used to position to other locations such as the end of the data archive.

Finally, in step 590, the high-speed pointer 150 and high-speed pointer validation information 151 is stored as part of the directory locator 140. This information allows the read head to be provided with instructions such that the read head may immediately advance to the desired location when reading the data archive.

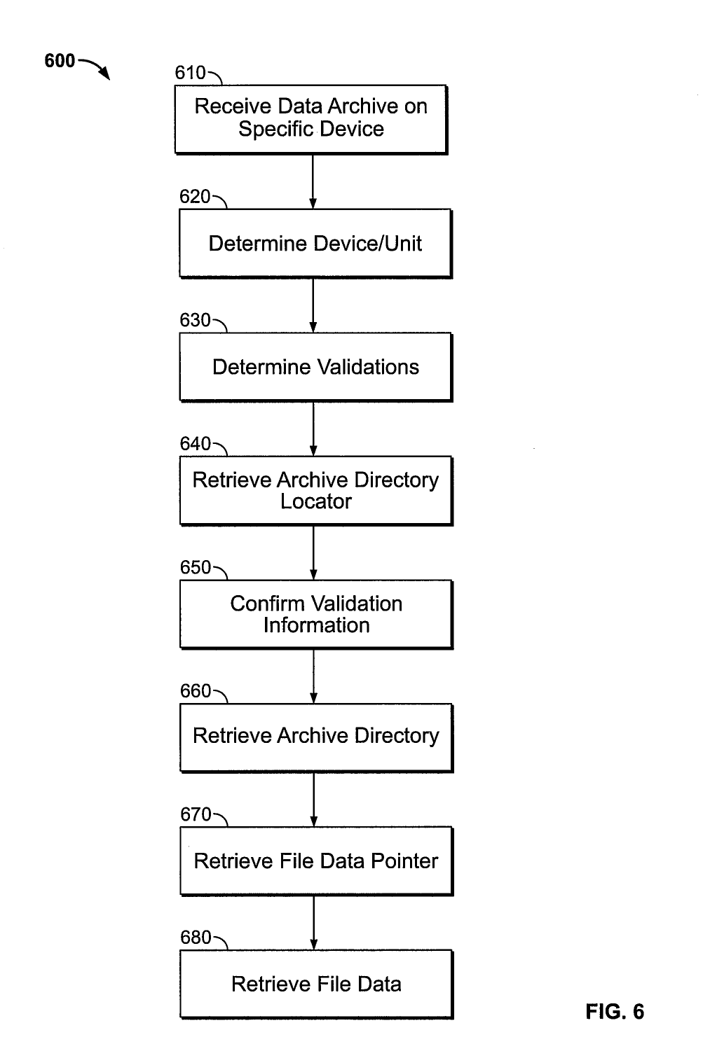

FIG. 6 illustrates a flowchart 600 of accessing a data file within a data archive. First in step 610, a process begins reading the directory locator. As described above a computer process may instruct a storage device to move a drive head to a position on a storage medium and access a data archive. Once the read head has accessed the data archive, the read head may locate and access the directory locator.

In step 620, information regarding the storage device is retrieved and confirmed. After the read head accesses the directory locator, the read head may acquire unique identifying information pertaining to the storage device or medium. As described above, this information may contain unique factory codes or any other information which may be used to identify the device and the type of storage media it utilizes.

Next, in step 630, validation information is retrieved from the data archive. This validation information may be retrieved from the information gathered in step 620. As previously described, the validation information may include device, media, volume, or other information that is subsequently used to confirm that high-speed pointers are able to be used to correctly position the read head of the device to read the data archive.

Then at step 640, the directory locator 140 is read. As previously described, the directory locator contains high-speed pointer information 150 and high-speed pointer validation information 151 for the data archive being read. The information within the directory locator may be used to access high-speed pointers that point to the location of an archive directory.

At step 650, the validation information gathered in step 630 is compared to validation information gathered in step 640. If the validation information matches, the high-speed pointers may be used to correctly position the read head of the storage device to read the data archive. If the validation information does not match, then the data archive may be read, but high-speed pointers are not available to be used to position the read head.

In step 660, the read head is advanced to the start location of the archive directory. The process controlling the read head references the physical or logical location referenced by the high-speed pointer and instructs the read head to advance to the physical or logical location referenced by the pointer. This advance is referred to as a “high-speed” advance because the read head does not perform sequential read operations when moving from the starting location to the location referenced by the pointer.

Then, the read head begins reading the archive directory. The read head accesses the information contained within the archive directory as described above. The archive directory information may be decrypted and/or decompressed. The information read may include high-speed file pointers to file data in the data archive. In one embodiment of the invention, high-speed pointer information for multiple files may be read in a single read operation eliminating the need for reading the archive directory information more than once. Further, high-speed pointer information for multiple files may be copied into computer memory where it may be further processed. One example of further processing is ordering the high-speed pointers for use favorable to the device and media.

At step 670, the read head retrieves a pointer referencing the physical or logical starting location of a file within a storage medium. The high-speed pointer referencing a file is read from the archive directory. Alternatively, the archive directory may contain high-speed pointers that reference the ending location of a file, or any other point corresponding to a file, or other metadata of a data archive.

Thus, as described above, various embodiments of the present invention provide systems and methods that allow for high speed access to data stored in data archives on physical media. The data may be accessed more quickly because information about the physical storage media is used to directly advance the process of reading data from the physical storage medium to a desired location on the physical storage medium to access a desired data element. Further, the process of reading data need not proceed sequentially through the entire data container to reach the desired data element or file, but may instead jump directly to a location on the physical media corresponding with a desired data element or file.

Finally, at step 680, the read head is advanced to the start location of the data file. The process controlling the read head references the physical or logical location referenced by the high-speed pointer and instructs the read head to advance to the physical or logical location referenced by the pointer. This advance is referred to as a “high-speed” advance because the read head does not perform sequential read operations when moving from the starting location to the location referenced by the pointer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for storing data in a data container, said method including:
storing data on a physical memory, wherein said physical memory includes a plurality of physical memory locations;
associating at least one of said physical memory locations with said data to form a physical memory location indicator; and
storing said physical memory location indicator in a data container.

2. The method of claim 1 wherein said data is also included in said data container.

3. The method of claim 1 wherein said physical memory location indicator is a pointer.

4. The method of claim 1 wherein said data container includes information about said physical memory.

5. The method of claim 1 wherein said physical memory location indicator indicates the position of the start of said data.

6. The method of claim 1 wherein said physical memory location indicator is stored in a data container separate from said data.

7. The method of claim 1 wherein said data container is in the .ZIP format.

8. A system for storing data in a data container, said system including:
a data container including data; and
a physical memory, wherein said physical memory includes a plurality of physical memory locations,
wherein said data is stored on said physical memory,
wherein at least one of said physical memory locations is associated with said data to form a physical memory location indicator,
wherein said physical memory location indicator is also stored in said data container.

9. The system of claim 8 wherein said data is also included in said data container.

10. The system of claim 8 wherein said physical memory location indicator is a pointer.

11. The system of claim 8 wherein said data container includes information about said physical memory.

12. The system of claim 8 wherein said physical memory location indicator indicates the position of the start of said data.

13. The system of claim 8 wherein said physical memory location indicator is stored in a data container separate from said data.

14. The system of claim 8 wherein said data container is in the .ZIP format.

15. A method for reading data, said method including:
reading, from a data container, a physical memory location indicator corresponding to a location on a physical memory where a desired data element is stored;
using said physical memory location indicator to advance the process of reading data from said physical memory to the location indicated by said physical memory location indicator; and
reading the data located at the location indicated by said physical memory location indicator

16. The method of claim 15 wherein said data is also included in said data container.

17. The method of claim 15 wherein said physical memory location indicator is a pointer.

18. The method of claim 15 wherein said data container includes information about said physical memory.

19. The method of claim 15 wherein said physical memory location indicator indicates the position of the start of said data.

20. The method of claim 15 wherein said physical memory location indicator is stored in a data container separate from said data.

21. The method of claim 15 wherein said data container is in the .ZIP format.

22. A system for reading data, said system including:
a data container including a physical memory location indicator corresponding to a location on a physical memory where a desired data element is stored; and
a physical memory, wherein said physical memory includes a plurality of physical memory locations,
wherein said data element is stored on said physical memory,
wherein said physical memory location indicator is read from said data container and used to advance the process of reading data from said physical memory to the location indicated by said physical memory location indicator in order to read the data located at the location indicated by said physical memory location indicator

23. The system of claim 22 wherein said data is also included in said data container.

24. The system of claim 22 wherein said physical memory location indicator is a pointer.

25. The system of claim 22 wherein said data container includes information about said physical memory.

26. The system of claim 22 wherein said physical memory location indicator indicates the position of the start of said data.

27. The system of claim 22 wherein said physical memory location indicator is stored in a data container separate from said data.

28. The system of claim 22 wherein said data container is in the .ZIP format.

29. A data container stored on a computer readable media, said data container including:
a data container, wherein said data container includes a physical memory location indicator associated with a data file,
wherein said data file physical memory location indicator references a physical memory location corresponding to said data file.

30. The data container of claim 29 wherein said data file is also included in said data container.

31. The data container of claim 29 wherein said physical memory location indicator is a pointer.

32. The data container of claim 29 wherein said data container includes information about said physical memory.

33. The data container of claim 29 wherein said physical memory location indicator indicates the position of the start of said data.

34. The data container of claim 29 wherein said physical memory location indicator is stored in a data container separate from said data.

35. The data container of claim 29 wherein said data container is in the .ZIP format.
